(19) United States
(12) Patent Application Publication
(10) Pub. No.: US 2004/0059789 A1
(43) Pub. Date: Mar. 25, 2004

(54) System and method for tracking messages in an electronic messaging system

(76) Inventor: Annie Shum, Hopkinton, MA (US)

Correspondence Address: WONG, CABELLO, LUTSCH, RUTHERFORD & BRUCCULERI,, P.C., 20333 SH 249, SUITE 600, HOUSTON, TX, 77070, US

(21) Appl. No.: 10/668,530

(22) Filed: Sep. 23, 2003

Related U.S. Application Data
(63) Continuation of application No. 09/536,244, filed on Mar. 27, 2000.
(60) Provisional application No. 60/162,568, filed on Oct. 29, 1999.

(51) Int. Cl. G06F 15/16

(52) U.S. Cl. 709/206; 709/203

(57) ABSTRACT

A method and system for tracking messages in an electronic mail messaging system. The electronic mail messaging system includes a plurality of electronic mail servers, wherein each respective electronic mail server includes message tracking software that logs message information regarding messages transferred through the respective electronic mail server. For example, the electronic mail messaging system may be the Microsoft Exchange Messaging System.

The electronic mail messaging system preferably includes a plurality of agent software programs, wherein an agent software program resides on each electronic mail server. The electronic mail messaging system further includes a central console which receives message information from each of the agents and operates to reconstruct end-to-end message flows in the electronic mail messaging system.

The central console decompresses the message information, and then operates to examine the message information regarding the messages transferred through each of the electronic mail servers. The central console then correlates the message information to determine an end-to-end message flow for each of the messages.

The end-to-end message flow may comprise a sequence of entrances and exits through one or more electronic mail servers as well as through one or more network links that connect two or more electronic mail servers. In one embodiment, the central console then may generate one or more reports using the message flow information. For example, the central console may generate various types of graphlets that show various enterprise information. Also, an administrator may use the message flow information, such as that contained in a report, e.g., a graphlet, to adjust a configuration of the electronic mail messaging system, such as server topologies, site topologies, etc.

### PRIORITY CLAIM

This application claims benefit of priority of provisional application Serial No. 60/162,568 titled “Application Transaction Tracking with an End-User Perspective for the Microsoft Exchange Messaging System” and filed Oct. 29, 1999, whose inventor is Annie Shum and co-pending, non-provisional application Ser. No. 09/536,244 filed Mar. 27, 2000 titled “System And Method For Tracking Messages In An Electronic Messaging System” whose inventor is Annie Shum. Both of the above two applications are incorporated herein by reference.

### BACKGROUND OF THE INVENTION

1. Field of the Invention

The present invention relates to enterprise monitoring and planning in electronic mail messaging systems, and more particularly to a system and method for tracking message flows end-to-end in an electronic mail messaging system, such as the Exchange messaging system.

2. Description of the Related Art

Until recently, email was generally viewed as a simple and un-ambitious application with a limited role in the infrastructure of a corporation. Along with the sweeping changes brought about by the growth of the World Wide Web, messaging and collaboration applications such as MS Exchange and Lotus Notes have become widespread today and are destined to be ubiquitous tomorrow. Electronic messaging systems have emerged as one of the top mission-critical applications for businesses. In general, electronic messaging has very high requirements for reliability, scalability, availability and manageability because it functions as the baseline infrastructure for many business applications, such as workflow and process automation.

This rapid transformation of corporate email applications from secondary to mission-critical importance has prompted research into understanding the performance and capacity planning requirements of Web-enabled messaging applications. It is first important to note the complexity of these messaging and collaboration applications and the variety of diverse functions they provide. MS Exchange is one example of a messaging system. MS Exchange is a client/server electronic messaging system with integrated GroupWare that facilitates communication by providing five main functions:

Electronic Messaging

Information Sharing and Collaboration

Group Scheduling and Personal Information Management

Electronic Forms

Application Design (e.g. helpdesk manager, document library, customer tracking system and electronic bulletin board.)

In fact, Exchange is an entire subsystem of its own with comprehensive tracking, logging, and other miscellaneous backup and disaster recovery functions. Moreover, the complexity of the Exchange messaging system extends well beyond its core functions. For Exchange to succeed as a successful global messaging system, it should be tightly and intricately integrated with the corporation's network topology and enterprise infrastructure: geography, backbone, LAN, WAN, Windows NT and protocols as well as connectivity to existing non-Exchange messaging systems. The performance of Exchange may be adversely affected by its less than finely-tuned surroundings; similarly, Exchange itself may become equally challenging to its environment. Tony Redmond, a renowned author on MS Exchange, summed it up as follows: “Much of the internal workings of Exchange servers remain hidden from the eye . . . Messages pass between servers without let or hindrance, network bandwidth is absorbed without permission, replication takes place in the background, and disk space is silently filled up . . . There is a lack of enterprise-wide monitoring and management tools, so knowing exactly what's happening on your Exchange servers is quite difficult.” Tony Redmond, Microsoft Exchange Server v5.0: Planning, Design, and Implementation (Newton, Mass.: Digital Press), 1997, 209 & 597.

There are fundamental differences between mission critical, web-enabled client/server applications and other more traditional client/server applications. One of the most striking differences is the performance expectations of end-users. Empowered by the Web, e-Business online consumers and email users have very high standards for performance: continuous availability, “anytime, anywhere connectivity” and quick response times are no longer options but requirements. As dissatisfied consumers may “renege” and end a transaction with a simple mouse-click, it becomes clear that the mantra of successful e-Business and email applications is attention to the end-user experience.

The following contains background on the Exchange messaging system's performance and its core components.

In order to understand an electronic messaging system, an example of an iconic messaging system familiar from everyday life is described, namely the US Postal Service. There are many close parallels between the MS Exchange messaging model and the post office. The comparison facilitates visualization and understanding of the system for newcomers to the world of electronic messaging.

Journey of a Message Through the Post Office

The local post office has long been a mainstay of communication. Due to geographical distances, post offices are scattered throughout the country to facilitate administration and mail delivery. Every town (or zone within a town, based on zip codes) has its own local post office. These offer a variety of services, ranging from basic services to specialized services that are offered only in selective central locations. Like the different post offices, mail also comes in different types: letters, postcards, packages, metered, bulk, certified, insured, overnight delivery, high priority, by air, by sea, etc. While the majority of the mail handled by the Postal Service is sent directly by end-users, additional mail is generated by the post offices (i.e., “overhead” mail) as well as mail indirectly generated by end-users; examples of “overhead” mail include mail returned undelivered, receipts requested by senders and inter-office administrative mail.

Every address in the country is affiliated with one local post office. This address and its corresponding post office information is maintained and updated (when necessary) in a directory. This directory serves as a roadmap for routing mail to the designated post office of the recipient, regardless of where the mail originates. Every post office has a general manager in charge of all maintenance tasks, including updates to the directory.

When end-users mail a message, a letter with the recipient's address on the envelope is usually deposited in a mailbox. The mail carrier collects it and brings it back to the local post office. Each post office maintains a copy of the up-to-date directory that maps addresses to post offices across the country, where a postal officer looks up the destination post office. The simplest resulting scenario is local delivery, in which the recipient address belongs to the same post office and the local postal carrier may deliver the mail directly. In all other scenarios, the recipient addresses belong to different post offices and require routing.

These pieces of non-local delivery mail are now sorted by another postal officer, the mail transfer agent, whose responsibility is to determine the best route for each piece of mail to be forwarded to its destination post office. Post offices are organized into geographical “sites.” The destination office may be in the same “site” as the local post office, or in another site, or even in another country. All post offices within a site are close enough to each other that the mail may be forwarded directly using postal carriers. Once the mail is routed from the sender post office to the destination post office, it may then be delivered to the recipient as a local delivery. A post office in another site is usually farther away and may require different delivery transportation such as train or airplane. Similarly, communicating with another country may require transport by air or by sea. Routing between post offices that are in the same site involves a direct transfer from the sender to the recipient post office: a one-hop route. In contrast, routing across sites or overseas may require multiple hops. Moreover, when the post offices send mail by air or by sea, there are additional “connections” and processing involved, i.e., transport to and from airports, etc.

Journey of a Message through the Exchange System

Comparison of the post office model to the MS Exchange Server messaging model is now described. Like the postal system, Exchange is a global messaging system that supports communication between one messaging system and another. Fortunately, international messaging standards exist that facilitate this cooperation. The X.400 standard, defined by the International Telegraph Union (ITU), seeks to establish standards so that users of different electronic messaging systems may exchange messages with each other transparently. Based on a store-and-forward messaging model, messages are forwarded from one server to another across LAN or WAN links, similar to the transfer of telephone signals across switches. Should there be any connection failure at any point, whether it is due to server or network unavailability, the messages are temporarily held in the forwarding server until connectivity is re-established.

The Exchange administrative infrastructure is also similar to the Postal Service model. At the top level of the Exchange infrastructure is the organization created in the Exchange system to represent the messaging enterprise of an organization (FIG. 1). Within an organization are a number of sites that host Exchange servers. A site may be based on functional or departmental boundaries; however, a site is typically a group of Exchange servers that are geographically close to each other, and all Exchange servers within the site are usually connected via a high bandwidth LAN (or high-speed WAN) connection. FIG. 2 shows an illustration of an Exchange organization with two sites.

Nonetheless, a site may span a very wide geographical area as long as there is sufficient network bandwidth. Designing site configurations and boundaries is a crucial part of capacity planning for Exchange that may significantly impact both performance and administrative effort.

An Exchange server may be considered the equivalent of a post office. More than one server may belong to the same site, and high bandwidth LAN or WAN links using synchronous RPC typically connect servers within a site. Just as every mailing address corresponds to a single post office, every user's email address belongs to a single Exchange server. This information is maintained in a local directory that is replicated across the entire Exchange organization.

There are four core components in the Exchange system. One is called the Directory Service (DS); it corresponds to the postal clerk who manages the address directory. The System Attendant (SA), whose primary role is to support the maintenance of the Exchange server, is similar to the post office's general manager. The Information Store (IS) is a structured repository for all the incoming messages to the Exchange server. It is responsible for delivery of all local messages and for forwarding non-local delivery messages to the fourth core component, the Message Transfer Agent (MTA). Built on the X.400 standard, the MTA routes messages to the MTA on other Exchange servers or other non-Exchange messaging systems. Capacity planning and performance considerations for these four core components will be addressed later in more detail.

When an Exchange client sends a message, its path across the Exchange system is not unlike that of mail through the Postal Service. The IS will use the directory through the DS to identify the Exchange server(s) of the recipient(s). Unlike a regular envelope or package, an Exchange message may be addressed to one or more recipients or to a distribution list. The IS will store the messages and then notify all the recipients that are local to its Exchange server, as shown in FIG. 3. If there is a distribution list as a recipient of the message, the IS will require the help of the MTA to perform the fan-out operation (note: distribution list expansion is an optional service of the Exchange server. An Exchange organization may choose to designate selected servers to expand the distribution list, in which case the original server must first route the distribution list to one of the designated servers for expansion).

FIG. 4 illustrates a local delivery that uses the MTA for distribution list expansion. Any non-local message that requires routing to another Exchange server will be processed by the MTA. How and when the message is delivered will depend on whether the recipient server is within the same site—an intrasite routing—or in another site—an intersite routing. Intrasite routing is point-to-point, single-hop and automatic. Exchange server supports intersite routing by means of “connectors” such as the X.400 or the Internet connector, IMS. Exchange server v5.5 supports a variety of connectors.

In addition to routing messages to the MTAs of other Exchange servers, the MTA also forwards messages to other non-Exchange messaging systems such as cc:Mail or MS Mail. As might be expected, different messaging systems store messages in different formats. For any message with a non-native Exchange format, the MTA will first perform envelope and content conversion prior to forwarding the message to a non-Exchange system. A notable exception is the Internet format conversion that is processed by the IS starting with Exchange Server v5.5. FIGS. 5 and 6 illustrate how Exchange performs intrasite and intersite routing, respectively.

As a message is forwarded from the sender Exchange server, the MTA selects the “best” route, using the Gateway Address Routing Table (GWART). Messages may be routed through multiple Exchange servers and sometimes re-routings may be required if there are link connection failures between a pair of Exchange servers. The configuration of the routes among servers is one of the key performance considerations in designing an Exchange messaging system; in fact, it plays a major role in focusing application transaction capacity planning on the end-user's experience.

FIGS. 7 and 8 highlight the Exchange model. FIG. 7 (authored by the Exchange development team) depicts the four core components of the server and its relationship with a wide variety of clients. FIG. 8 provides a birds-eye view of the message flow inside an Exchange server, again highlighting the four core components of the Exchange server and their roles in the routing of a message through the system.

In addition to availability, another important issue is performance. A primary issue in the optimization of backbone and network topology design is to reduce network traffic. This is because network bandwidth is a valuable but costly commodity. Empowered by the World Wide Web, there is a growing phenomenon of runaway bandwidth consumption compounded by enormous files that are freely transferred over the Web. The resulting heavy network traffic directly impacts message delivery times and creates bottlenecks. In the case of Exchange, as discussed previously, there are scores of different messages that flow through the messaging system. Besides the expected interpersonal messages from clients, Exchange messages may come from the system attendant (SA), the directory service (DS), and the public information store (IS). The bulk of these messages are generated by the system: intrasite directory replications and routings, intersite replication and routings, NDRs (non-delivery reports: an NDR is a notification received by an Exchange client indicating failure of delivery to the recipient), time-outs and retries, link monitors and server monitors, etc. To reach the goal of reducing network traffic, an administrator should 1) tune the directory service and directory replications, public folder replications and the MTA; and 2) understand and tune the Exchange site topology including the choice of messaging connectors; and track the network traffic to find out the sources and destinations of messages.

Following is a brief summary of some of the issues a capacity planner should consider in formulating a capacity planning strategy. For more information on capacity planning issues, please see the provisional application Serial No. 60/162,568 referenced above, which is hereby incorporated by reference as though fully and completely set forth herein.

Events outside of Exchange may impact the performance of Exchange. A “root cause” analysis of performance problems needs to look beyond the server-centric, and even beyond Exchange itself.

Site, Server, Network Topology and Configuration are all integral parts of the Exchange messaging system. Transport protocols and connectors in intrasite versus intersite routing are key players. Exchange clients are multifaceted and heterogeneous; workload characterization is critical to capacity planning. Not all Exchange servers are alike: server roles are configurable options. Similarly, not all messages are alike; they have diverse resource requirements. System-generated message load may overwhelm the system. Understanding message transaction workflow and message routes is essential to capturing the essence of the system in order to design the system around the end-user experience.

In general, some of the fundamental deployment/configuration issues for capacity planners include site boundaries, number of servers in a site, server roles, and number of clients per server. In order to perform capacity planning in an enterprise electronic mail messaging system, more information is needed then is presently available.

Some enterprise electronic mail messaging systems include performance monitoring software for performing a server-centric type of monitoring. For example, the Microsoft Exchange electronic mail server software includes performance monitoring software referred to as “PerfMon”. PerfMon is a server-centric monitor, and it provides a number of performance metrics that may readily be applied to server management. However, while there are still a variety of metrics that are related to the network and backbone usage, there is a real need for “beyond server-centric” metrics, such as server to server and site to site metrics. Consider the metric of message rate. In order to perform regular site topology tuning, message rate information is desired for server to server and site to site. From PerfMon, metrics for each server may be obtained, but there is no obvious or direct way to break down the total server outbound message rate into outbound message rates by individual recipient server or by individual site. The same dilemma is faced with server inbound message rates. Moreover, while the site message rates may be calculated by simply adding up the message rates for all the servers within that site, again there is no direct way to break down the site message rates by site components.

There are a variety of network tools that may be deployed to monitor the availability of the network components that connect Exchange servers and sites. By and large, these tools are from third-party vendors and are not specific to the Exchange messaging system. A notable exception is the Link Monitor that is bundled in the Exchange server CD. Although the link monitor is by no means a general-purpose network monitor, it allows an administrator to monitor the status of connections between servers for the Exchange system; in fact, an administrator may even monitor connections to sites that have non-Exchange messaging systems. Like the Exchange server monitor, the link monitor may be configured to send alerts and notifications. The server and link monitors are part of the SA of the Exchange server. Most Exchange practitioners recommend using the link monitor on all “important sites” in an organization, preferably from a central server.

It is certainly important to have continuous connectivity monitoring of the Exchange system. However, it is very important to keep in mind the potential performance degradation caused by aggressive use of the link monitors. After all, link monitors operate by sending active ping-like messages to all the servers the SA configured for the link monitor. In order to estimate the “round-trip” time between a server hosting the link monitor and any other remote servers being monitored, the ping-like messages are dispatched at regular intervals. The administrator may configure the frequency of the messages as well as the threshold value for the “bounce duration”, namely the round-trip time for the ping message. The link monitor is a useful tool but it is not an ideal solution; a better solution is non-invasive performance management tools that are also scalable.

The first consideration in enterprise client/server management is the end-user experience, as quantified by message delivery times. Capacity planners of every client/server mission critical application have been searching for non-invasive and scalable management solutions to track transaction response times. At the moment, the available solutions provide at best only limited and partial support. The Exchange link monitors provided by Microsoft are neither non-invasive nor scalable. Third-party vendors fare better. Their approaches appear to be variations on the strategy of measuring the round trip delivery times of a test message from any server to other servers.

The measurement of test message delivery times may be applied in real-time to determine which servers are experiencing unsatisfactory delivery times. While this may be an acceptable strategy for a limited number of servers and test scenarios, it is not clear how it would scale for large enterprise organizations. In order to cover the (N) Exchange servers, there are (N)² connectivity scenarios to consider and each test scenario will increase the original message load with the synthetic test messages.

For at least the foregoing reasons, there is a need for an improved system and method for performing capacity planning in an electronic mail messaging system in a more efficient manner. More particularly, there is a need for determining end-to-end message flow information in an enterprise messaging system.

### SUMMARY OF THE INVENTION

The present invention provides various embodiments of an improved method and system for tracking messages in an electronic mail messaging system. The electronic mail messaging system includes a plurality of electronic mail servers, wherein each respective electronic mail server may include message tracking software that logs message information regarding messages transferred through the respective electronic mail server. For example, the electronic mail messaging system may be the Microsoft Exchange Messaging System.

The electronic mail messaging system preferably includes a plurality of agent software programs, wherein an agent software program resides on each electronic mail server. The electronic mail messaging system further preferably includes a central console which receives message information from each of the agents and operates to reconstruct end-to-end message flows in the electronic mail messaging system.

In one embodiment, message tracking logs are enabled in each of the plurality of electronic mail servers, and message tracking software operates to collect and store the message information at each of the plurality of electronic mail servers. The agent software programs then transfer the message information from each of the plurality of electronic mail servers to the central console. Each of the agent software programs preferably compresses and transmits the message information to the central console. The message information may include a message id, source server name, destination server name, time stamp information, and size information, among others.

The central console decompresses the message information, and then operates to examine the message information regarding the messages transferred through each of the electronic mail servers. The central console then correlates the message information to determine an end-to-end message flow for each of the messages. For example, some of the messages originate from a sender server of a client who sends the message, propagate through zero or more intermediate servers, and then arrive to a recipient server of a recipient of the message. In this example, correlating the message information to determine an end-to-end message flow for each of the messages comprises, for each message, reconstructing the message flow of the message from the sender server to the recipient server. Thus, for a first message, correlating the message information includes examining first message information of the first message from a first server, determining time stamp information of the first message using the first message information, determining a destination server of the message using the first message information, wherein the destination server becomes the first server, and repeating the above steps one or more times until the destination server is the recipient server of the message. The above steps essentially operate to reconstruct the message flow of the message.

The central console then generates message flow information for the first message and stores the message flow information in a database. The message flow information may describe the end-to-end message flow for each of the messages. The end-to-end message flow may comprise a sequence of entrances and exits through one or more electronic mail servers as well as through one or more network links that connect two or more electronic mail servers. In one embodiment, the central console then may generate one or more reports using the message flow information. For example, the central console may generate various types of graphlets that show various enterprise information. Also, an administrator may use the message flow information, such as that contained in a report, e.g., a graphlet, to adjust a configuration of the electronic mail messaging system, such as server topologies, site topologies, etc.

### BRIEF DESCRIPTION OF THE DRAWINGS

A better understanding of the present invention may be obtained when the following detailed description of various embodiments is considered in conjunction with the following drawings, in which:

FIG. 1 illustrates an Exchange organization with one site;

FIG. 2 illustrates an Exchange organization with two sites;

FIG. 3 illustrates the IS storing messages and then notifying all the recipients that are local to its Exchange server;

FIG. 4 illustrates a local delivery that uses the MTA for distribution list expansion;

FIGS. 5 and 6 illustrate how Exchange performs intrasite and intersite routing, respectively;

FIG. 7 depicts the four core components of the server and its relationship with a wide variety of clients;

FIG. 8 provides an overview of the message flow inside an Exchange server, again highlighting the four core components of the Exchange server and their roles in the routing of a message through the system;

FIG. 9 illustrates an exemplary enterprise messaging environment or system according to one embodiment;

FIG. 10 is a flowchart diagram illustrating operation of an agent software program comprised in each of the electronic mail servers of FIG. 9 according to one embodiment;

FIG. 11 is a flowchart diagram illustrating operation of a central console software program comprised in the central console server of FIG. 9 according to one embodiment;

FIG. 12 is a flowchart diagram illustrating more detail regarding reconstructing message flows in the flowchart of FIG. 11 according to one embodiment;

FIG. 13 illustrates a site topology total message rate graphlet at 3 pm GMT according to one embodiment;

FIG. 14 illustrates a site topology total message rate graphlet at 12 am GMT according to one embodiment;

FIG. 15 illustrates a summary tabular view of the data for the graphlet shown in FIG. 13 according to one embodiment;

FIG. 16 illustrates a detailed tabular view of the data for the graphlet shown in FIG. 13 according to one embodiment;

FIG. 17 illustrates a site topology interpersonal message rate graphlet according to one embodiment;

FIG. 18 illustrates a Top Ten Sender graphlet based on delivery times according to one embodiment;

FIG. 19 illustrates a graphlet containing the top five messages for one of the Top Ten Senders shown in FIG. 18 according to one embodiment;

FIG. 20 illustrates a send message delivery route graphlet displaying the path of a single message through the system according to one embodiment;

FIG. 21 illustrates a send message delivery route graphlet displaying the path of a single message through the system in which network delivery time is the cause of delay according to one embodiment;

FIG. 22 illustrates a network latency graphlet according to one embodiment;

FIG. 23 illustrates a Top Ten Sender graphlet based on message size according to one embodiment; and

FIG. 24 illustrates a graphlet containing the top four messages for one of the Top Ten Senders shown in FIG. 23 according to one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF SEVERAL EMBODIMENTS

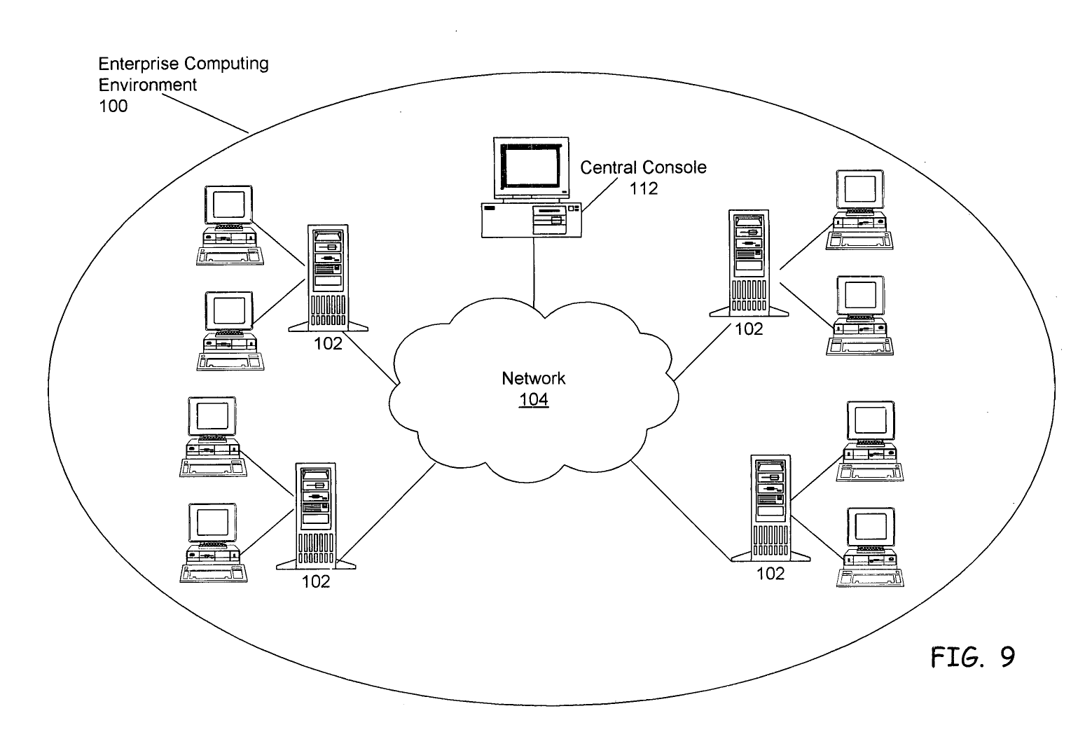

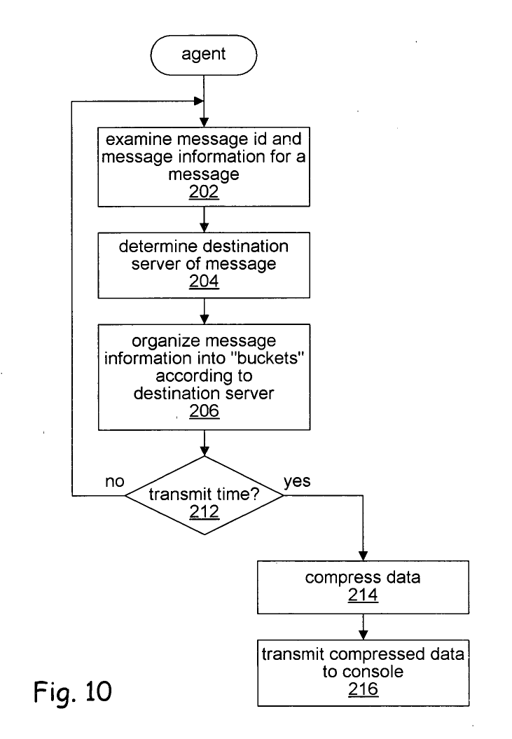

FIG. 9: An Enterprise Computing Environment

FIG. 9 illustrates an exemplary enterprise messaging environment or system according to one embodiment of the present invention. The enterprise messaging environment is preferably an electronic mail messaging system for providing electronic mail connectivity within an enterprise. However, the enterprise messaging environment or system may operate to provide other types of messaging or data routing, as desired. The following describes the preferred embodiment of the present invention, which is used in an enterprise electronic mail messaging system, preferably an enterprise electronic mail messaging system using Microsoft's Exchange electronic mail server software.

As used herein, the term “message” is intended to includes various types of messages or data transmitted between clients or servers, such as electronic mail messages, instant messaging messages, etc. The term “electronic mail message” refers to standard email transmitted between clients or servers, including electronic mail between client users as well as electronic mail between electronic mail servers to facilitate the operation of the enterprise messaging environment. Thus, the term “message” includes various types of “message transactions”, as discussed below. The term “electronic mail message” is often referred to herein simply as “electronic mail”, an “email message”, a “message”, or “email”.

As shown, the enterprise computing environment 100 includes a plurality of electronic mail servers 102 which are interconnected via the network 104 in the enterprise 100 according to one embodiment. A plurality of client computer systems may be coupled to each of the electronic mail servers 102.

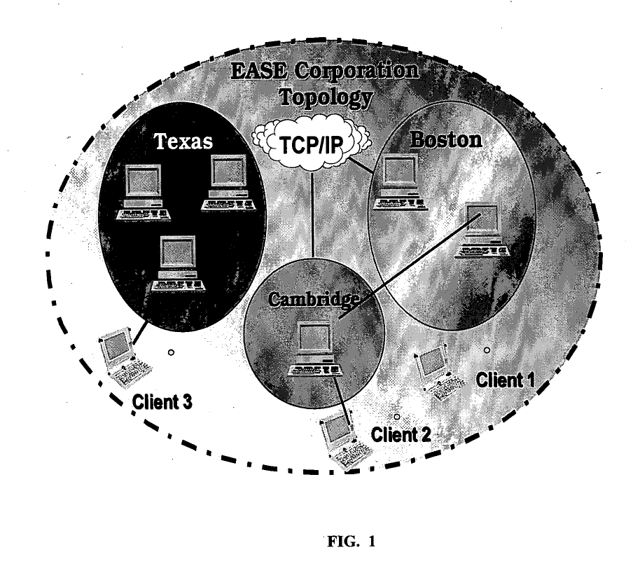

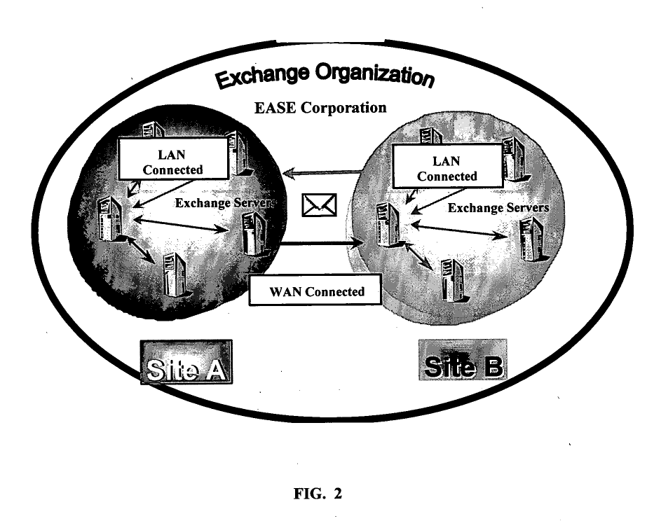

The enterprise computing environment 100 may be arranged in any of various ways. The plurality of electronic mail servers 102 may be coupled together in any of various ways, including one or more local area networks (LANs), one or more wide area networks (WANs), the Internet, or combinations thereof. Also, the enterprise computing environment 100 will generally include a number of other systems or components which are not shown in FIG. 1, such as file servers, routers, bridges, hubs, printers, etc., as would be customary in an enterprise computing environment.

Each of the electronic mail servers 102 preferably includes electronic mail server software which is executable to enable the servers to operate as electronic mail servers. An example of electronic mail server software is the Exchange software program provided by Microsoft.

Each of the client computer systems may include electronic mail client software for sending and receiving electronic mail within the enterprise or outside of the enterprise. An example of electronic mail client software is the Outlook software program provided by Microsoft. Thus, each of the client computer systems may send electronic mail messages to each other, wherein the electronic mail messages are routed or processed by the electronic mail servers 102. As noted above, each of the electronic mail servers 102 may also send electronic mail messages to each other to support the electronic mail system.

When a client user sends an email message, the email message is first provided to a sender server of the client who sent the message. The email message may then be routed through zero or more intermediate servers until the email message arrives at a recipient server which corresponds to the recipient client of the message. Thus, an electronic mail server 102 who originates or sends a message is referred to as the sender server, and an electronic mail server 102 which is the final destination server of the message is referred to as the recipient server. Thus, for example, a message may originate from a sender server of a client who sends the message, propagate through zero or more intermediate servers, and then arrive to a recipient server of a recipient of the message. When there are no intermediate servers, the sender server may also be the recipient server, or the recipient server may be different than the sender server.

Each respective electronic mail server 102 preferably logs message information regarding messages transferred through the respective electronic mail server 102. More specifically, each electronic mail server 102 may include a message tracking log for collecting and storing the message information at each of the plurality of electronic mail servers. In one embodiment, the system of the present invention may include agent software programs stored in each of the electronic mail servers 102 which operate to transfer the message information from each of the plurality of electronic mail servers 102 to a central console computer system 112. If the electronic mail servers 102 do not include message tracking logs, then the agent software programs in each server 102 may perform the function of both logging message information and transferring the message information to the central console 112.

As shown, the central console 112 may also be coupled to the enterprise computing environment 100. In one embodiment, the system of the present invention may include a central console software program stored in the central console computer system 112. As discussed further below, the central console 112 is operable to examine the message information regarding the messages transferred through each of the electronic mail servers 102, correlate the message information to determine an end-to-end message flow for each of the messages, and store message flow information in a database in response to the correlation. The central console 112 may further generate reports based on the message flow information. An operator of the central console 112 may use the database to generate reports based on the message flow information. The operator of the central console 112 may also use the database and/or reports to adjust a configuration of the network.

Each of the electronic mail servers 102 and the central console computer system 112 may include various components as is standard in computer systems. For example, the electronic mail servers 102 and the central console 112 may include one or more processors or CPUs, random access memory, non-volatile memory, and various internal buses, etc. as is well known in the art.

The electronic mail servers 102 and the central console 112 preferably include a memory medium on which computer programs according to various embodiments may be stored. The term “memory medium” is intended to include an installation medium, e.g., a CD-ROM, or floppy disks, a computer system memory (random access memory) such as DRAM, SRAM, EDO RAM, Rambus RAM, etc., or a non-volatile memory such as a magnetic media, e.g., a hard drive, “DASD”, or optical storage. The memory medium may include other types of memory as well, or combinations thereof. Also, the electronic mail servers 102 and the central console 112 may take various forms, including a personal computer system, mainframe computer system, workstation, network appliance, Internet appliance, personal digital assistant (PDA), television system or other device. In general, the term “computer system” may be broadly defined to encompass any device having a processor which executes instructions from a memory medium.

The memory medium preferably stores a software program or programs for performing tracking of messages as described herein. The software program(s) may be implemented in any of various ways, including procedure-based techniques, component-based techniques, and/or object-oriented techniques, among others. For example, the software program may be implemented using ActiveX controls, C++ objects, Java objects, Microsoft Foundation Classes (MFC), or other technologies or methodologies, as desired. A computer system executing code and data from the memory medium comprises a means for executing the software program or programs according to the methods and/or diagrams described below.

Various embodiments further include receiving or storing instructions and/or data implemented in accordance with the description herein upon a carrier medium. Suitable carrier media include storage media or memory media such as that described above, as well as signals such as electrical, electromagnetic, or digital signals, conveyed via a communication medium such as networks 104 and/or a wireless link.

FIG. 10—Agent Software Operation

FIG. 10 is a flowchart diagram illustrating operation of an agent software program running on an electronic mail server 102 according to one embodiment. As noted above, in the preferred embodiment, each of the electronic mail servers 102 in the enterprise, i.e., in the electronic mail messaging system, may include an agent software program. The agents executing in each of the electronic mail servers 102 operate to transmit message information to the central console 112.

In one embodiment, such as where the Microsoft Exchange messaging system is used, the electronic mail server software on each of the electronic mail servers 102 includes performance monitoring software which operates to monitor the performance of messages arriving in and passing out of the respective electronic mail server. This message information is monitored and logged into a log file of each electronic mail server 102. More specifically, the Exchange server software provides a mechanism to enable detailed message tracking across the system, in order to support problem tracking for system administrators. The message tracking facility in the Exchange Administrator may be used to track the path of all the messages through entry and exit points in the Exchange servers. Note that message tracking is enabled on the site level. Message tracking may be disabled for a particular server in a site by modifying the value in the key \SYSTEM\CurrentControlSet\Services\MSExchangeMTA (or IS) of the Windows NT Registry.

In the preferred embodiment, message tracking is enabled on all Exchange servers. The effectiveness of the system described herein may be compromised unless message tracking is enabled for the entire site and organization. Thus message tracking is preferably enabled on all Exchange servers for a message to be fully tracked up to the point of delivery. If one server in the path has message tracking disabled, the message may only be tracked until it reaches that server, where a dead end would be reached

Within each server, messages are tracked in two primary components, the MTA and the IS. Message tracking may optionally be enabled for either or both components; IS tracking is for local delivery messages and MTA tracking is for cross server messages. In the preferred embodiment, message tracking is enabled on both the MTA and IS, essentially tracking all messages for the server. This is recommended for the capacity planning methodology described herein.

Once message tracking is enabled, the server records details of the message journey, providing a record for each message transaction the server generates. A new tracking log is created for each server at GMT (Greenwich Mean Time) midnight (GMT is chosen as the default time zone to support multiple time zones in the Exchange enterprise). Each Tracking log is named in the Y2K compliant format YYYYMMDD.log and may be stored in a TRACKING.LOG directory. By default, the tracking log for a server will reside on the server for seven days, but this duration is customizable by the administrator.

Message tracking in Exchange is similar to events tracking for most applications. It is noted that there is a potential for performance degradation due to tracking despite the tremendous benefits of the detailed information collected. Tracking will generally require additional CPU and I/O resources. Moreover, the Exchange tracking logs may quickly grow in size, especially for busy servers. Typically, one may expect a daily tracking log file on a moderately busy server dedicated to user mailboxes to be about 10 to 15 MB, while a server with the IMS connector might generate 10 to 20 MB of logs on a busy day.

In general, the benefits provided by the tracking logs will outweigh the potential performance impact. To realize the potential of the tracking logs beyond problem tracking and diagnostics, the tracking logs should be used as tools for beyond server-centric capacity planning and performance management solutions according to the present invention. Unlike link monitors, the tracking logs are not invasive monitoring tools and may be scalable even in large Exchange environments.

Thus, where each of the respective electronic mail servers 102 includes message tracking software, it is presumed that message tracking logs, or simply message tracking, has been enabled in each of the plurality of electronic mail servers. This enables each of the electronic mail servers 102 to track messages and store the corresponding message information in a log file. Thus, each of the plurality of electronic mail servers 102 operate to collect and store message information as messages pass through the respective servers. For example, the Microsoft Exchange Messaging Server software includes a performance monitoring program referred to as “Perfmon” which operates to perform this message tracking.

As noted above, in one embodiment, each of the electronic mail servers 102 also includes an agent software program according to one embodiment of the invention which operates to collect this message information and provide it to the central console 112.

As shown, in one embodiment of the invention, in step 202 the agent software program in a respective server 102 operates to examine the message tracking log file to determine the message id of respective messages and the corresponding message information associated with each message id. The message id is an identifier for a respective message, and the log file includes message information such as the message id and corresponding information such as source server name, destination server name, time stamp information, and size information. The source server name refers to the server name of the source server from which the message was transferred, which may be the sender server or an intermediate server. The destination server name refers to the server name of the server to which the respective message is to be transferred, which may be an intermediate server or the recipient server. The time stamp information may refer to a time stamp made when the message was first received at the respective electronic mail server 102 and a second time stamp corresponding to when the message was transferred from the respective electronic mail server 102. The size information refers to the size of the entire message, including the content of the message.

In step 204 the agent software preferably determines the destination server of the message. Thus, the agent software preferably examines the destination server name and the message id and determines the destination server where the message is to be transferred based on this information. In step 206 the agent preferably organizes the message information for the various respective messages into “buckets” or data structures according to the respective destination server to which the message is being transferred. Step 206 may be performed for each message or at various intervals.

In general, a message may originate from a sender server of a client who sends the message and will propagate through zero or more intermediate servers and then finally arrive to a recipient server which corresponds to a recipient of the message. For a respective electronic mail server, the source server is the immediately prior electronic mail server in the message flow or transfer path of the respective message, if any, and the destination server of the message is the next successive electronic mail server in the message flow or transfer path for the respective message, if any.

Steps 202-206 are repeated a plurality of times for each respective message that passes through the respective electronic mail server until the transmit time occurs. When the transmit time occurs as determined in step 212, processing passes to step 214. In step 214 the agent software preferably compresses the one or more data structures which contain the message information organized into data structures or “buckets” and transmits the compressed data to the central console 112 in step 216. In the preferred embodiment, the transmit time is 12:00 Greenwich mean time (GMT). Thus, in one embodiment, every 24 hours the agent software program operates to compress and transmit the various message information that has been organized into data structures or “buckets” according to the destination server. In one embodiment, the agent organizes the message information into buckets at periodic intervals, or only once immediately prior to compressing and transferring the data in steps 214 and 216.

Thus, the agent software programs operate in each of the electronic mail servers 102 to perform this function, thus providing information from each of the electronic mail servers 102 to the central console 112.

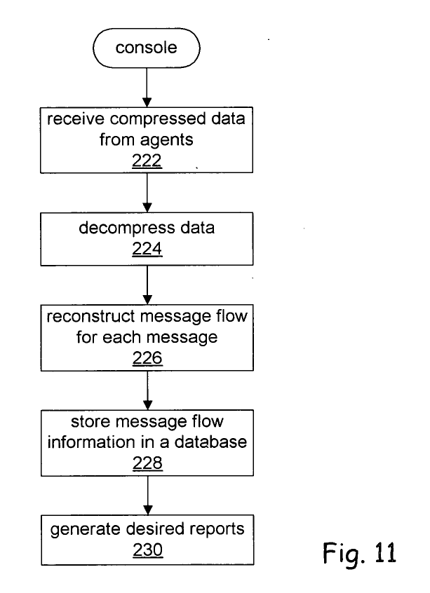

FIG. 11—Central Console Operation

FIG. 11 is a flowchart diagram illustrating operation of the central console 112 according to one embodiment.

As shown, in step 222 the central console 112 receives compressed data from each of the plurality of agents. The generation of the compressed data by the agents is described above with respect to the flowchart of FIG. 10. In step 224 the central console 112 decompresses the data to produce uncompressed data. The uncompressed data corresponds to the message information for each of the messages received by a respective electronic mail server 102 for each of the plurality of electronic mail servers 102. As noted above, the message information from each electronic mail server 102 is preferably organized into data structures or buckets according to the respective destination server for each message, i.e., the destination server relative to the respective electronic mail server from which the message information was received.

The organization of the message information by each of the agents in step 206 greatly reduces the amount of work performed by the central console 112 in reconstructing message flows. Each of the software agents essentially perform a distributed processing function in organizing the message information at each of the servers 102, thus removing this burden from the central console 112.

In an alternate embodiment, the agent software program does not organize the message information into data structures or buckets according to the respective destination server, i.e., step 206 of FIG. 10 is not performed, but rather simply sends the message information as it is collected in the electronic mail servers 102. This reduces the processing load slightly at each of the servers 102, at the expense of a greater processing load performed by the central console 112.

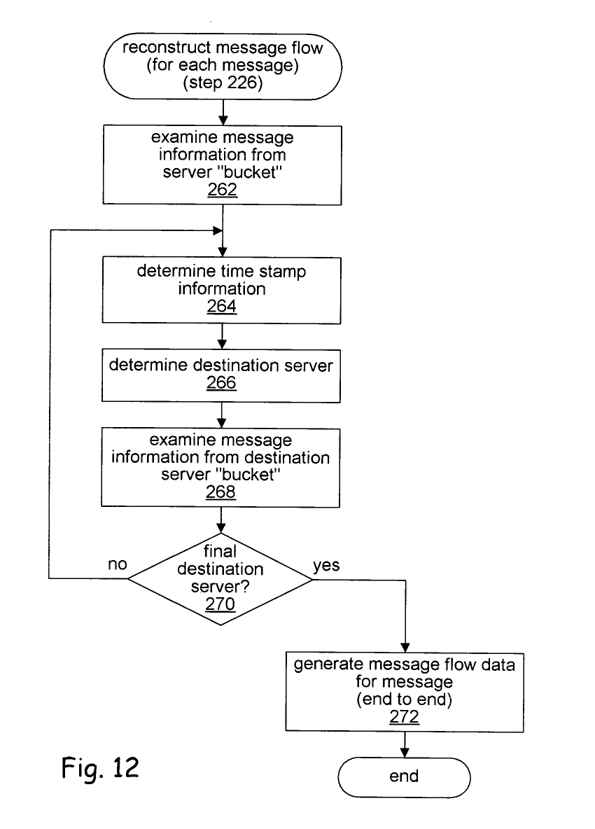

In step 226 the central console 112 operates to reconstruct the message flow for each message. Step 226 is discussed in greater detail with respect to the flowchart of FIG. 12. In general, step 226 involves the central console 112 examining the message information received from the various agents and correlating this information to reconstruct the message flow or message transfer path from the beginning or sender server to the final destination or recipient server.

In step 228 the central console 112 stores the message flow information reconstructed in step 226 into a database, preferably an ODBC database. In step 230 the central console 112 may generate various desired reports, either automatically or as requested by an administrator of the central console 112. In addition, an administrator may take various desired actions in response to this message flow information or the generated reports, such as adjusting the enterprise in various ways. For example, the administrator may adjust one or more of server(s) topology and configuration, site topology and configuration, network topology and configuration, or various other capacity planning adjustments, e.g., to “tune” the system. For information on various capacity planning adjustments that may be made, please see the discussion below as well as the provisional application referenced above.

FIG. 12—Reconstructing Message Flows

FIG. 12 is a flowchart diagram illustrating operation of step 226 of FIG. 11 according to one embodiment. More specifically, FIG. 12 is a flowchart diagram illustrating the reconstruction of the message flow performed in step 226 of FIG. 11 for one message according to one embodiment. FIG. 12 illustrates reconstruction of the message flow for a single message.

As shown, in step 262 the central console 112 examines the message information for a respective message from a respective server bucket or data structure.

In step 264 the central console 112 determines time stamp information from the respective message information of the message. The time stamp information may include the received time stamp and the transmit time stamp of the message within the respective electronic mail server.

In step 266 the central console 112 determines the destination server to which the message is to be transmitted or forwarded from the respective electronic mail server. As noted above, this destination server may be an intermediate server in the message path or may be the final recipient server. In other words, this destination server is the next or subsequent destination server relative to the respective electronic mail server 102 from which the message information is being examined.

In step 268 the central console 112 examines the message information from the destination server bucket, i.e., examines message information for the respective message from the data structure received from the destination server identified in step 266. Stated another way, having determined the destination server in step 266 to which this respective message is being transferred to next, in step 268 the central console software 112 examines the message information for this respective message from that destination server identified in step 266. If this destination server is not the final destination server as determined in step 270, then steps 264-268 are repeated. Thus, steps 264 through 268 are repeated one or more times to essentially reconstruct the message flow or transfer path of the message as it traveled through the enterprise from the sender server to the recipient server.

Once the final destination server has been identified in step 270 for the respective message, then in step 272 the central console 112 generates message flow data for the message. This message flow data describes the end-to-end path taken by the respective message through the enterprise from the sender server, through the zero or more intermediate servers, then finally to the recipient server. As noted above, the sender server and the recipient server may be the same server, e.g., if the sender and recipient are comprised within the same site hosted by or served by the same electronic mail server 102.

Therefore one embodiment of the system utilizes a beyond server-centric approach using message log information, such as that found in the Exchange message tracking logs. The servers generate the tracking logs to provide problem tracking and diagnostics. However, these logs contain information that may be used to reconstruct an end-to-end message flow, allowing an enterprise-wide analysis that takes into account message flows. The system operates to correlate the logs to reconstruct the end-to-end message flow of the messages. Correlation of the logs involves the central console 112 methodically following the journey of the Exchange messages across the Exchange enterprise. The correlation of these logs enables the system to make the giant leap from server-centric capacity planning to enterprise transaction tracking and to focus planning on the end-user experience.

Measuring Message Load Based on Message Flow Information

When measuring the message load on an electronic mail messaging system, such as the Exchange system, it is important to count message transactions instead of simply client messages. While a message transaction is itself a message, it is imperative for purposes of capacity planning to distinguish between a client message versus a message transaction. Every unique message will spawn one or more message transactions as the server processes the message. The actual number of message transactions for each message may vary widely depending on the characteristics of the message itself. As an example, assume a client who sends an email to a list of 100 recipients that includes a nested distribution list. This one email message will generate multiple message transactions: one for the local recipient, one for each recipient group through a connector, plus any additional system messages such as NDRs, re-routes, etc. As each message transaction flows across the servers to reach its recipient server, new message transactions will be generated for the intermediate servers. Thus, the number of unique client messages will always be smaller than the number of message transactions generated by the messaging system. This is an important point to keep in mind when formulating a capacity planning strategy.

Example Message Flows

By and large, traditional capacity planning tools are server-centric or network-centric. As discussed above, the system described herein operates to understand the message flow through the different components of the system and the network. This helps to encapsulate the end-user experience in a capacity planning study for the Exchange system. This allows an administrator to grasp the end-user's perspective by following a typical Send Message from a client and analyzing its flow across the system. The message flow is a sequence of entrances and exits through a number of servers as well as the network links that connect the servers. As used herein, a “segue” is an entrance and an exit through one server. As used herein, a “sender server” is the server of the client who initiates the sending the message and a “recipient server” is the server of the recipient. An “intermediate server” is any server used for intermediate routing from the sender server to the recipient server.

A Send Message flow is made up of one or more segues. It will contain a sender server, a recipient server and possibly one or more intermediate servers.

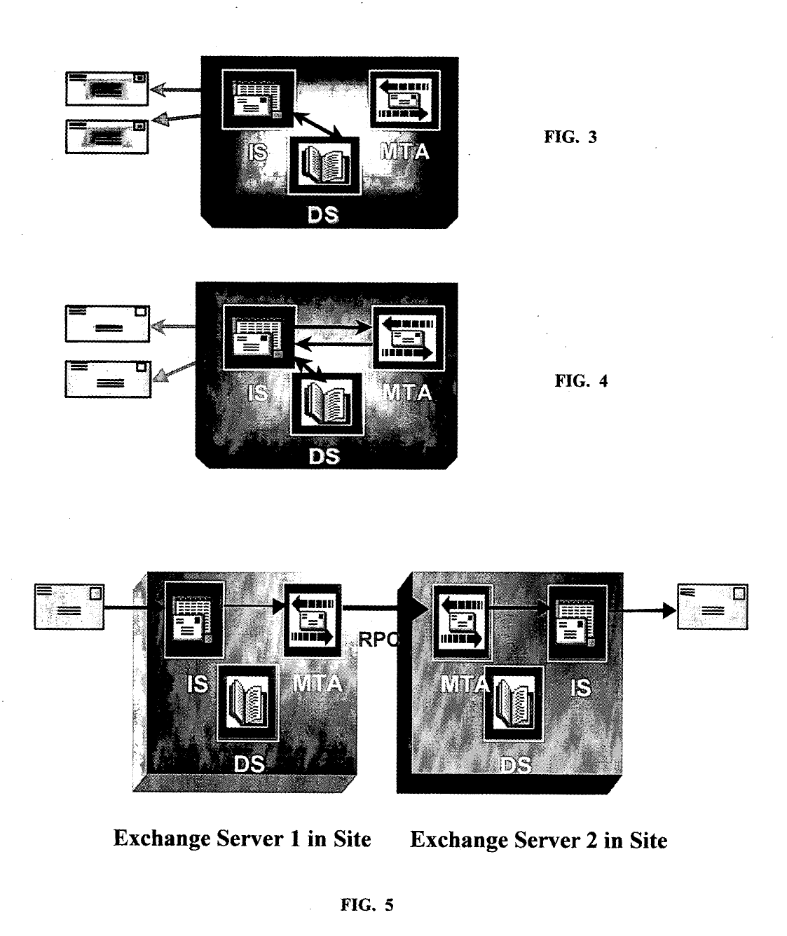

The following describes the outbound segue through the sender server, followed by the inbound segue through the intermediate server. It may be helpful to refer to FIGS. 3-8 (from the “Description of the Related Art” section) as the message's journey is followed. The description of message flows below helps to explain operation of the central console 112 in reconstructing message flows.

Message Flow from the Perspective of the Sender Server

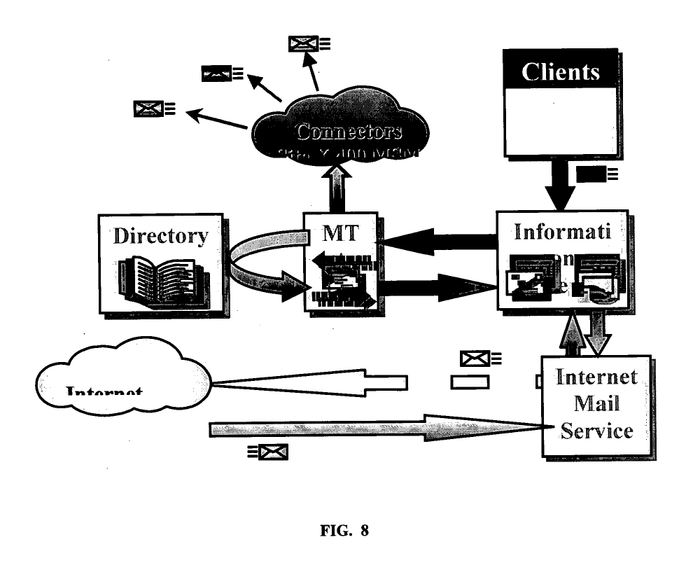

The journey begins when an Exchange client sends a message to one or more recipients (FIG. 8). The message arrives at the host server for the client, typically through RPC connections. The message is transferred to the Information Store (IS).

The IS, with the help of the directory service (DS), determines whether any of the recipients of the message belong to the host server. The IS sends a notification message to each local delivery recipient individually (FIG. 3). Here lies another key point for capacity planners: as discussed above, a single message will generally spawn multiple messages during its journey through the servers. To be precise, these spawned messages should be distinguished as message transactions while the original messages sent by clients are referred to as unique messages. However, both spawned messages and unique messages are generally referred to herein as “messages”.

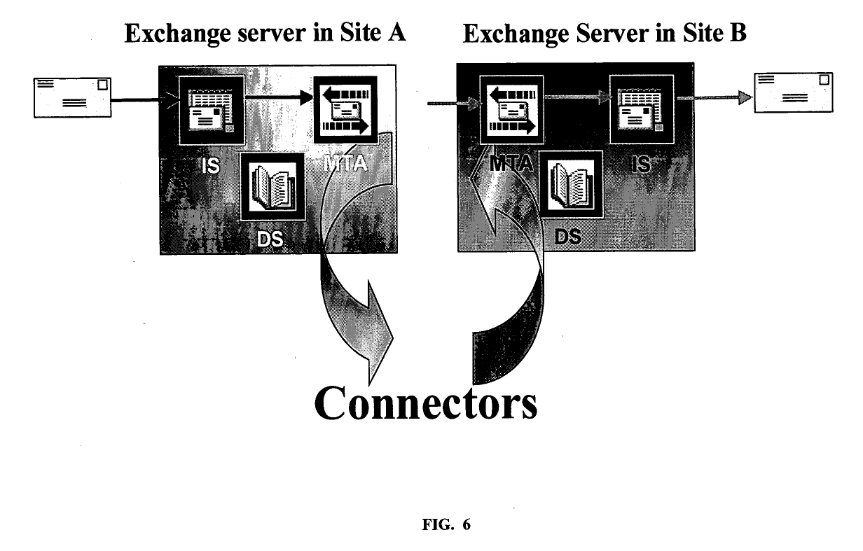

If there is a distribution list as part of the recipient list, then IS first notifies the MTA to expand the distribution list (see FIG. 6). If the server role of the host MTA does not include the distribution list expansion, the message will have to be routed to another server with the DL expansion role.

For all the remaining recipients that have addresses that belong to other servers, the IS transfers these recipient addresses to the MTA for further routing.

The MTA begins the process to determine the “best” route for each of the non-local recipients by first performing a directory look-up through the DS. The MTA then determines whether any of the recipients belong to a non-Exchange messaging system. MTA transfers the message for these particular recipients to the corresponding “gateways” by means of the IS component. To accomplish this, the MTA relies on the Gateway Address Routing Table (GWART) that is maintained by the System Attendant (SA). Note that the MTA will not perform any content or format conversion for any non-Exchange messaging systems that use gateways for routing; it converts content for X.400 and SMTP mail only. It is the responsibility of the gateways to perform all the necessary conversion and further delivery towards the final destination. An example of such gateways is the cc:Mail Connector. While its name is a connector, it is a true gateway that is very different from the Exchange messaging connectors discussed earlier. Besides the gateways provided by Microsoft, third party connectors and gateways would be required for other non-Exchange messaging systems such as IBM PROFS, SNADS, DEC All-in-One, AT&T EasyLink, VMSmail, Novell MHS, Lotus Notes, Fax, etc.

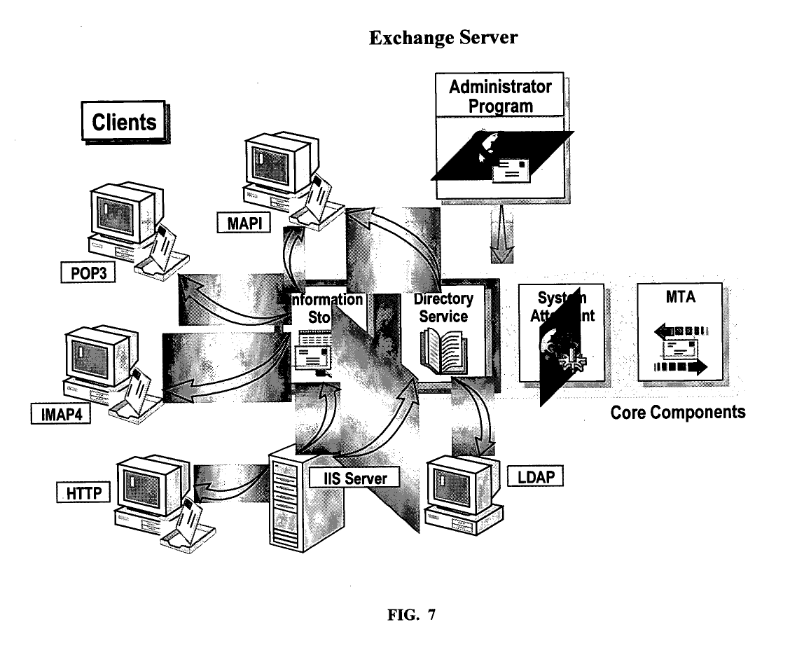

The rest of the recipients are now destined for other Exchange servers (see FIGS. 7 and 8). Based on the information from the GWART, MTA performs the following routing algorithm:

If the recipient belongs to another server on the same site, MTA directly transfers the message to the MTA of the recipient server. Recall from the earlier discussion that all intrasite connections are made with synchronous RPC connections. The host MTA attempts to establish connections and then transfers the message to this adjacent MTA. The journey of this message in the inbound segue is followed below.

If the recipient belongs to another server on another site, then depending on the GWART, the MTA will perform the routing through one of the connectors.

Site Connector: in this case, the MTA attempts to establish direct RPC connection with the MTA on the target server of the remote site. Upon successful connection, the message may be immediately transferred without any content conversion.

X.400 Connector: the local MTA transmits the message to the MTA of the bridgehead server in the other site. It may take more than one site hop for the message to reach its destination server. The need for content and format conversion between native Exchange format and the X.400 format is noted above; however, the SA may configure to disable the content conversion process.

IMS Connector: Since Exchange server v5.0, the content conversion between native Exchange format and the SMTP format is performed by the IS component. Furthermore, MTA and IMS do not directly interact. Instead, any message destined for IMS will be routed by MTA to IS. Subsequently, IS will transfer the message into the Outbound folder of IMS to await further routing through the IMS connector.

Every group of recipients that may be routed through the same connector will trigger an inbound segue of its own.

This ends the outbound segue of the Send Message through the server. Note that only the primary flow has been described. In addition to the primary events, there may be additional secondary events such as message transactions due to NDRs, re-routings, etc.

Message Flow from the Perspective of the Intermediate Server

There are slight variations for the inbound scenario depending on the messaging connector from which the incoming message arrives:

Case 1: The inbound message arrives at the intermediate server through an adjacent MTA either because of a site connector connection or an intrasite connection. From the discussion of the outbound journey, it may be realized that each inbound message represents another message transaction. An outbound message will typically trigger one or more inbound messages. The message now proceeds as follows:

MTA performs a directory look-up on the recipient names and checks for the validity of the recipients. Unless the message is rejected, MTA writes the message to the MTA work queue (the DAT files of the Exchange server).

If the recipient addresses are local to this server, MTA transfers the message to the IS for normal local delivery. Otherwise, it continues the routing and determines whether it is intrasite or intersite. The rest of the flow is as described in the outbound journey above. At this juncture, the inbound segue has generated new message transactions and once again becomes an inbound segue to the next server. In other words, the complete journey of a typical message may be made up of one outbound segue and one or more successive inbound segues as the spawned message transactions take off on journeys of their own. This is crucial to an end-user perspective in capacity planning for the Exchange messaging system.

Case 2: The inbound message arrives at the server through an X.400 connector. This implicitly requires the host server to be a bridgehead server for the X.400 connector from the originating site.

The MTA receives a request for an X.400 connection. Upon establishing the connection and having verified that the recipient is valid, the MTA temporarily places the incoming message in the MTA work queue.

If the conversion option is enabled, the MTA first performs the content and format conversion from X.400 to native Exchange. Again, for connection between Exchange servers, the conversion overhead may be avoided through careful configuration.

The MTA again consults the DS to do a directory look-up for the recipient and determine the route. It may be local, intrasite or intersite. The rest of the process continues as described above.

Case 3: The inbound message arrives at the server via an SMTP connection such as the IMS of the preceding server.

The MTA receives a request for an IMS connection. This step is similar to step 1 of the X.400 connection in case 2 above. Again the MTA temporarily places the message in the MTA work queue.

The MTA now transfers the message to the IS which in turn checks whether the recipient is local to the server.

If the recipient is local, then IS performs the necessary content and format conversion from SMTP to native Exchange format. All SMTP, POP 3 and HTTP messages that are local to this server are required to undergo conversion in the IS.

The IS stores the converted message in the local recipient's mailbox and sends out a delivery notification message to the recipient. If the recipient is not local, IS transfers the message back to MTA without conversion. The rest of the MTA routing decision is as described earlier.

End-User Message Delivery Time

As noted above, there are three general types of common activities for the end-users, namely, Send Message, Read Message and Server Directives for Mailbox Maintenance. Each of these types is considered in turn starting with the Send Message request. Based on the Send Message flow, the definition of delivery time for this message type may be formulated. There are three stages in the journey of a Send Message:

1) the sender client sends the message to his/her home Exchange server;

2) the message passes through the Exchange messaging system: from the sender server, to zero or more intermediate servers, and finally to the recipient server; and

3) the recipient client receives the mail notification from the Exchange recipient server.

At a high level, the three stages may be viewed as “client-centric” for stage 1 and stage 3 and as “Exchange-centric” for stage 2. Within stage 2, there may be periods when the message is outside of the system, such as during its transit from one Exchange server to another through the Internet or the X.400 backbone. The three stages with time-stamps may now be delineated. In order to support different time zones within the organization, all time-stamps will be in GMT. In addition, it is assumed that the clocks on the Exchange servers are correctly synchronized.

| | | |
|---|---|---|
| Stage 1: | Sender client sends the message (client-centric) | T_{S} |
| Stage 2: | Entry into Exchange system (Exchange-centric) | |
| | Enter sender server | T₁ |
| | Exit sender server | T₂ |
| | Enter intermediate server | T₃ |
| | Exit intermediate server | T₄ |
| | Enter recipient server | T₅ |
| | Exit recipient server | T₆ |
| Stage 3: | Recipient receives mail notification (client-centric) | T_{R} |

Note that the number of intermediate servers in Stage 2 will vary; there may be no intermediate server, one or several, depending on the routing. Moreover, the recipient server may be the same as the sender server for local delivery.

The delivery time of the Send Message begins when the sender client sends the message and ends when the client recipient receives the notification message sent by the recipient server. Calculating the delivery time is a simple subtraction of the “begin” from the “end” time-stamp. In addition to the delivery time itself, the time spent in each server as well as the network latency for each server hop may be determined. In other words,

| | |
|---|---|
| Send Message Delivery Time = | T_{R}-T_{S} |
| Network Latency Between Sender & Server = | T₁-T_{S} |
| Time Spent in Sender Server = | T₂-T₁ |
| Network Latency 1 = | T₃-T₂ |
| Time Spent in Intermediate Server = | T₄-T₃ |
| Network Latency 2 = | T₄-T₄ |
| Time Spent in Recipient Server = | T₆-T₅ |
| Network Latency Between Server & Recipient = | T_{R}-T₆ |

Calculating the Send Message delivery time as well as its delay components is a simple process if the time-stamps are available. Based on the earlier discussion of the tracking logs, time-stamps T₁ through T₆ may be derived for Stage 2, provided all the tracking logs have been correlated from each server in the message path. The time-stamps for the client-centric stages, namely T_{S} and T_{R}, will be missing from the tracking logs because the current Exchange tracking mechanism only applies to Exchange servers and not to individual clients. This is where some compromises may be made; here are a few alternatives to consider:

Provide an extension to the current tracking log to include the individual clients. This may be difficult, especially if the tracking software is required to run in every client's machine. After the earlier brief discussion of clients, one may appreciate the complexity of support tracking for multifaceted and heterogeneous clients.

For each message sent, a time-stamp showing when the client sent the message (corresponding to T_{S}) is recorded in the message itself. If the messages are still available (and not deleted), it is conceivable that the time-stamp could be retrieved for each message. Similarly, the received time-stamp would also be recorded by Outlook. While this alternative may be plausible, it is not a robust solution.

Consider the Send Message delivery time to be the time in Stage 2. In other words, the Send delivery time is now derived from T₆-T₁. This alternative is generally a reasonable approximation. The two missing pieces represent the network delays from sender client to sender server and from recipient server to recipient client. Since clients communicate with the servers using RPCs, the network delays are generally insignificant. If necessary, there are some simple techniques to estimate the network delays between a client and its server. For example, the TCP/IP traceroute command is one such technique. Using the latter to augment the Send Message delivery time, the final calculation is:

Delivery Time=(T₆-T₁)

+traceroute (sender client, sender server)

+traceroute (recipient server, recipient client)

In the case of a Web browser client, the delay between the client and the server will have to include another component, namely the Internet server. For Exchange, the Web browser client communicates with IS via the Exchange Active server component, which in turn sends the request to the Exchange server using MAPI calls.

For a typical end-user, the most common messaging commands after Send Message are Read Message and Directives for Mailbox Maintenance. Unlike the Send Message command, the path of a Read Message through the system is less complex. Usually, the client sends a read request to his server and the server sends the reply back to the client; only one client and one server are included in this path, so the delivery time will equal the round-trip network delays between the client and his server. The delay is likely to be minimal because it is a local delivery. Again, one may approximate these network delays by using traceroute commands. Alternatively, there are third-party vendors that provide specialized tools (agent software installed on the client's machine) to capture these round-trip delays for Exchange clients. Finally, the last type of end-user request is a Directive for Mailbox Maintenance task such as moving folders, deleting messages, etc. This is very similar to the read message, and the message delivery time is again the round-trip time between the client and his server.

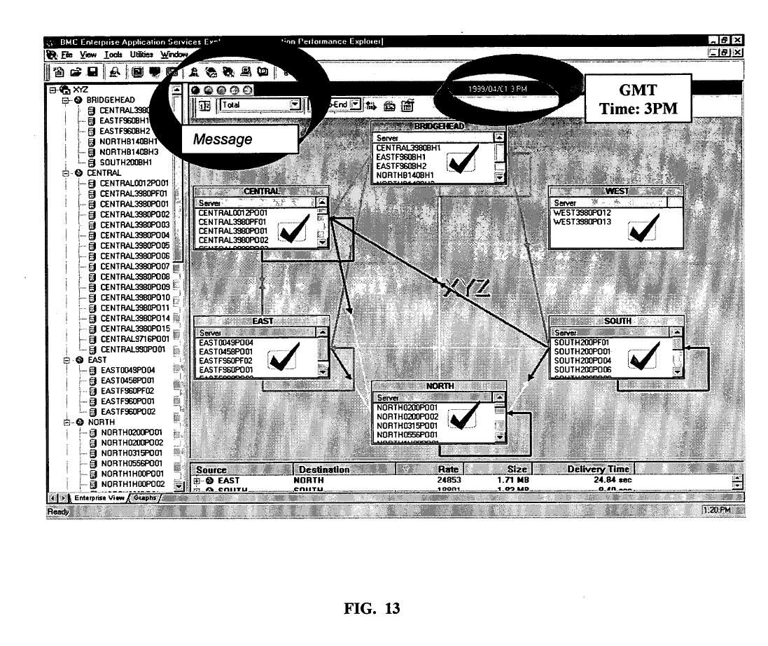

FIGS. 13-17: Sample Site Topology Graphlets

Upon analyzing and reconstructing the message flows as described above, various capacity planning reports may be generated and/or capacity planning operations may be performed in response to this information as mentioned above.

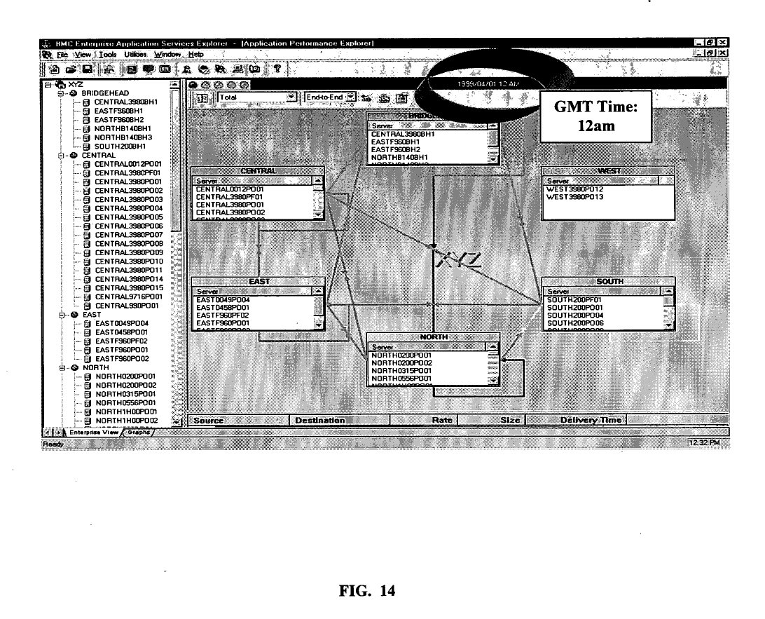

For example, one may create site topology graphlets, such as to track the message rates between sites and servers. The message flow information is preferably stored in an ODBC-compliant database so that one may readily create different graphlets based on various attributes. For example, FIG. 13 shows a site topology total message rate graphlet. It is noted that the message rates shown here are the actual message transaction rates. For brevity, message transaction rates will be simply referred to herein as message rates. FIG. 13 shows the inbound and outbound total message rates for each site to any other site during a particular hour. Using the ODBC database, one could create the same graphlet each hour for trending analysis. For example, FIG. 14 is almost identical to FIG. 13 except that the hour selected is midnight GMT instead of 3 PM GMT.

The system for the case study in FIG. 13 is based on a real-life production Exchange deployment with six sites in the organization “XYZ Corporation”. The familiar Windows tree-view on the left-hand side of FIG. 13 shows the hierarchy: organization XYZ, followed by the six sites (i.e., Bridgehead, Central, East, North, South, West) and the servers within each site (i.e., the server names begin with their respective site name, followed by a unique identifier). The site boundaries are generally based on geographical locations and the sites are named accordingly: North, South, East, West and Central. The site named Bridgehead is different; it includes all the dedicated bridgehead servers in the organization.

Notice that the number of servers in each site is very different. For example, there are only two servers in the site West but there are 17 in site Central and more than 80 servers in site East (not explicitly shown). The graphlet itself presents an Enterprise Exchange site topology. The six sites are separately displayed (identified by a checkmark), each with its own list of servers. The sites are linked together by the message flows, inbound and outbound. The colors of the links represent the value of the message rates themselves. Here, capacity planners may customize the colors of the links to provide visual alerting of potential problems.

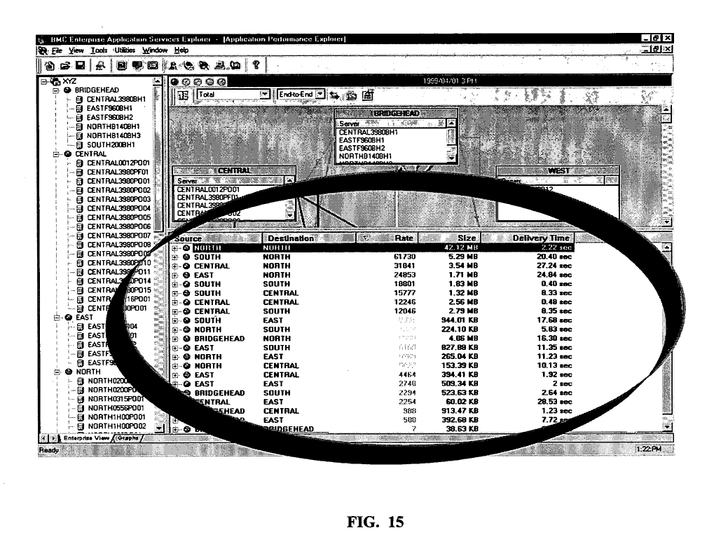

FIG. 15 shows the tabular view of the actual data for the graphlet shown in FIG. 13. To highlight the tabular view, there is a circle surrounding the data columns. The data include the total message rates between each pair of sites (source and destination).

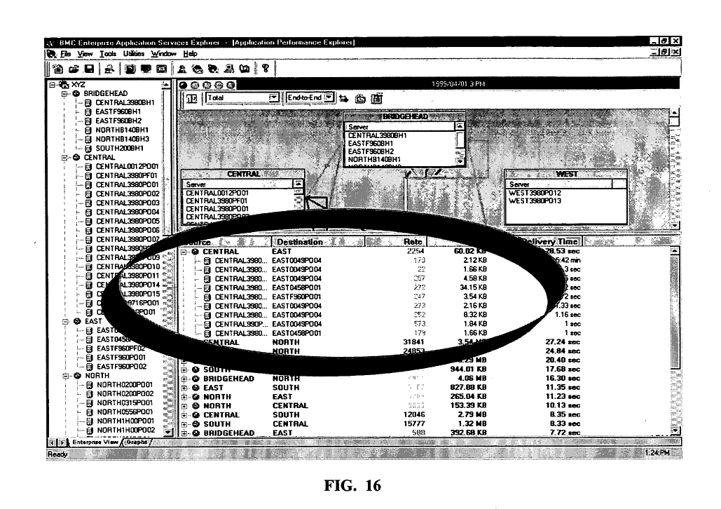

FIG. 16 is similar to FIG. 15, but the tabular view represents the next level of data detail, showing total message rates between each source and destination server pair within the site.

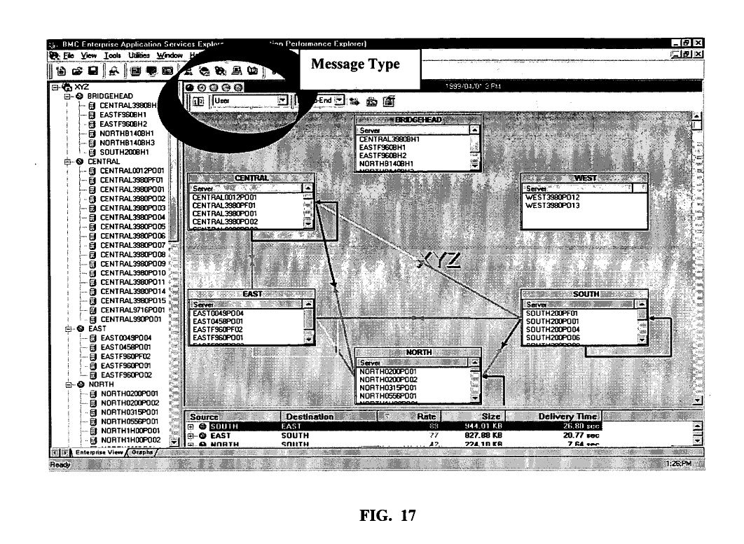

Due to the diverse nature of the different message types, it is important to track messages by type. While FIG. 13 depicts the total message rate graphlet, FIG. 17 instead shows interpersonal message rates. One can just as quickly create similar variations for rates of directory replication, public folder replication rates, NDRs or IMS messages, to name a few.

Besides tracking the message rates between sites and between servers, capacity planners can use the graphlets as shown in FIGS. 13-17 to perform health-checks on site topology configurations. In FIG. 17, for example, notice that there is a high message rate (as shown by the red color of the link, or see the data table) outbound from site Central to site North, but not inbound. The same is true for the outbound message flow from South to North, but not inbound. Now take a look at the other hours during the day and see if the same problems persist. If the answer is yes, then the immediate question for a capacity planner is: Why is there so much intersite network traffic? A related question is: Are the site boundaries optimal or should some of the servers be relocated to another site to reduce intersite network traffic? The graphlets can readily assist a capacity planner in fine-tuning site topology configurations.

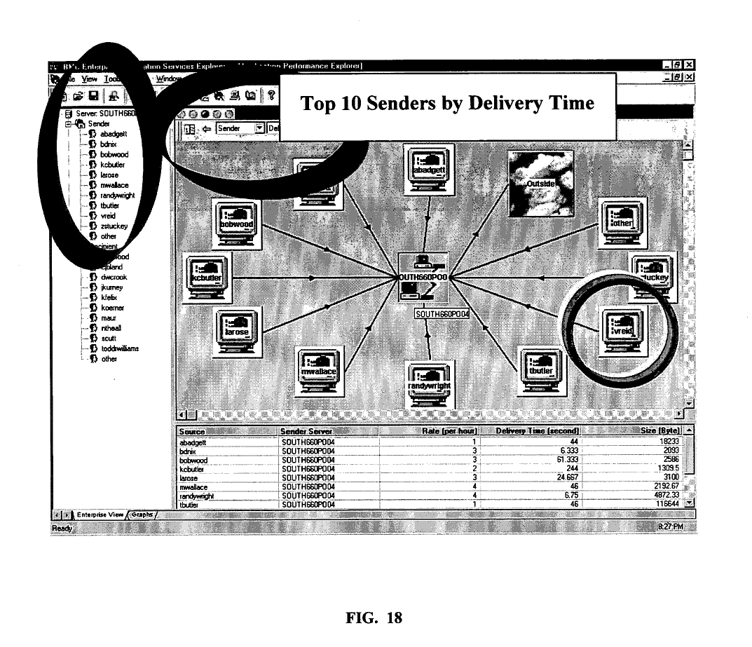

FIGS. 18-24: Sample Message Delivery Time Graphlets

Using the correlated tracking log data, i.e., the reconstructed message flow information, one may create multi-dimensional views of Exchange performance data by users and their messages.

An administrator may select a particular user and track his messages, or the administrator may use the Top (N) approach to track users. There are at least three essential criteria for selecting Top (N) users: top message size, top message transaction rate or top message delivery time. FIG. 18 shows a Top Ten Sender graphlet for the same case study as in FIG. 13.

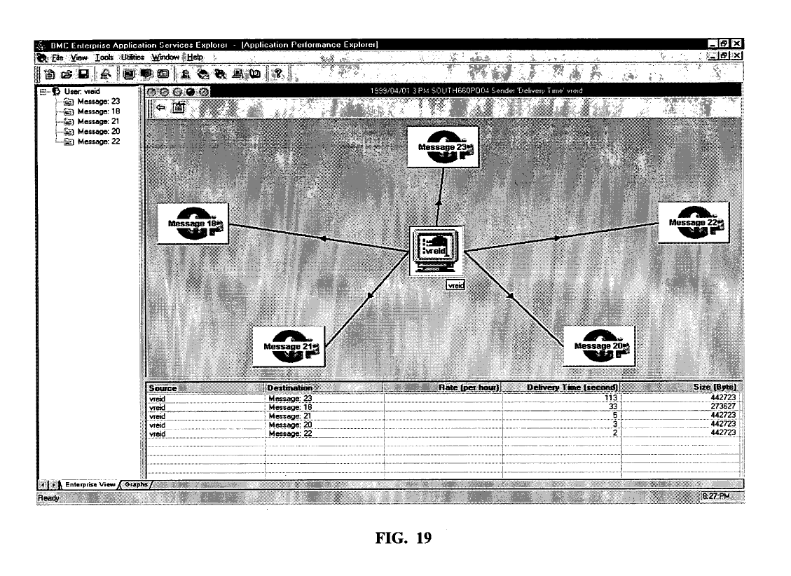

The “Top 10 Senders” criterion for FIG. 18 is based on Send Message delivery time. In other words, FIG. 18 shows, for a particular Exchange server, the ten users with the longest Send Message delivery times. Next, one of these top ten senders may be selected and his messages which have the longest delivery times may be found. For example, the sender selected is circled in FIG. 18 (i.e., user vreid). Following this sender, FIG. 19 reveals the five messages sent by user vreid with the longest send delivery times.

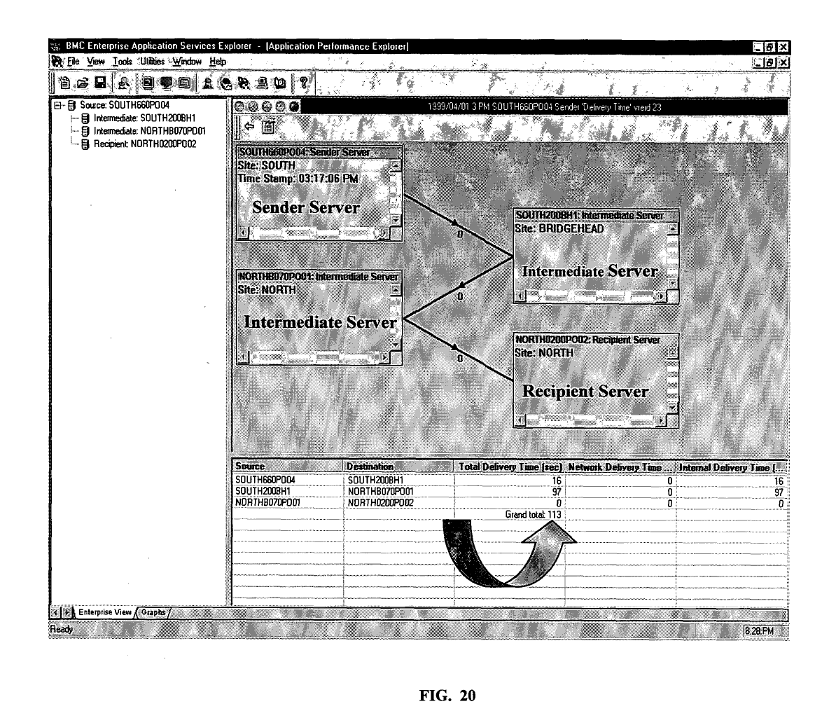

From FIG. 19, the crucial point is reached where the particular messages that have long delivery times for this sender may be identified. By examining one message and following its complete message route, performance problems may be identified. FIG. 20 illustrates a Send Message delivery route graphlet displaying a message's path through the system. It starts with the sender server in the Exchange site South, and the first intermediate server is a bridgehead server in site Bridgehead. The message journey continues from the bridgehead server to another intermediate server in site North. Finally, the recipient server is also in site North. Thus the Send Message from the sender has to traverse 4 different servers and three sites. The sites, as mentioned earlier, are named based on geographic locations and the Exchange sites are connected by WAN links.

Taking a closer look at the data view on the bottom of the graphlet in FIG. 20, the Send Message delivery time is broken down into individual components, including both servers and network latencies. The grand total of the message delivery time is 113 seconds. The first segue shows that the time spent at the sender server is 16 seconds, and there is minimal network delay between the sender server and the first intermediate server. (Regrettably, the time stamps recorded by the Exchange tracking logs have limited precision; any time difference less than a second will show zero). The second segue takes 97 seconds for the journey between the bridgehead server and the intermediate server; again, most of the time is spent at an Exchange server, an intermediate server in this case. Finally, the third segue between the intermediate and recipient servers has almost no delay, nor is there any delay in the recipient server.

It comes as no surprise that the intermediate server in site North has long delays, because it is a bridgehead server for site North. Since it has been identified that delays occur at the internal delay in the intermediate server in site North, server performance statistics reported by PerfMon may be used to finish the investigation. The MTA work queue length for one of the connectors may turn out to be very large, which directly contributes to the long delay in this server.

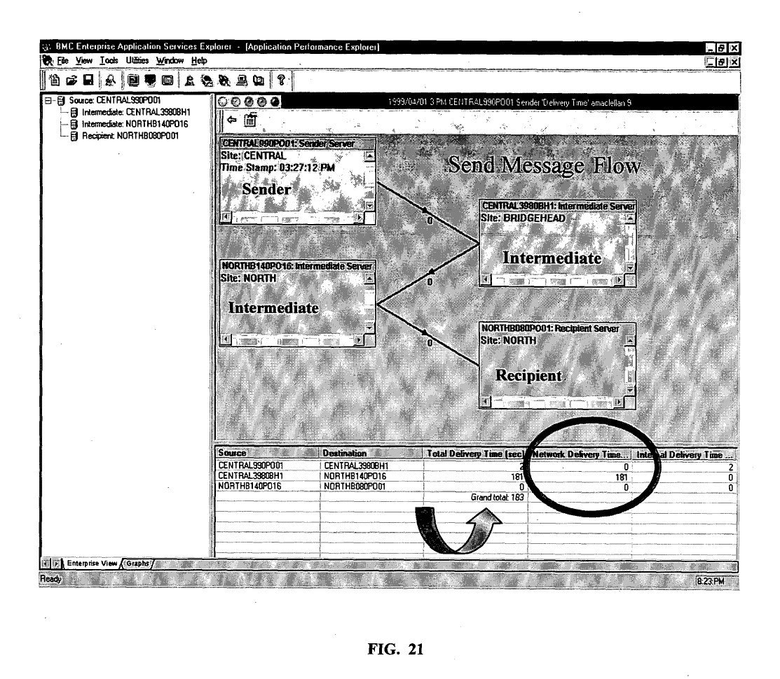

The performance tuning opportunities for message delivery times are certainly not limited to the internal delays within the Exchange servers. In the next example, a message whose long delivery time is due to the network latency is illustrated (see FIG. 21).

The Send Message shown in FIG. 21 starts with the sender server in site Central. As in the previous example, it is routed to the bridgehead server in site Bridgehead first and then to the intermediate server in site North before it reaches its destination server in site North. Looking closely at the delivery time of 183 seconds, the internal delay in the bridgehead server turns out to be a very small two seconds. However, the network delay from the bridgehead server to the intermediate server in site North is a very large 181 seconds!

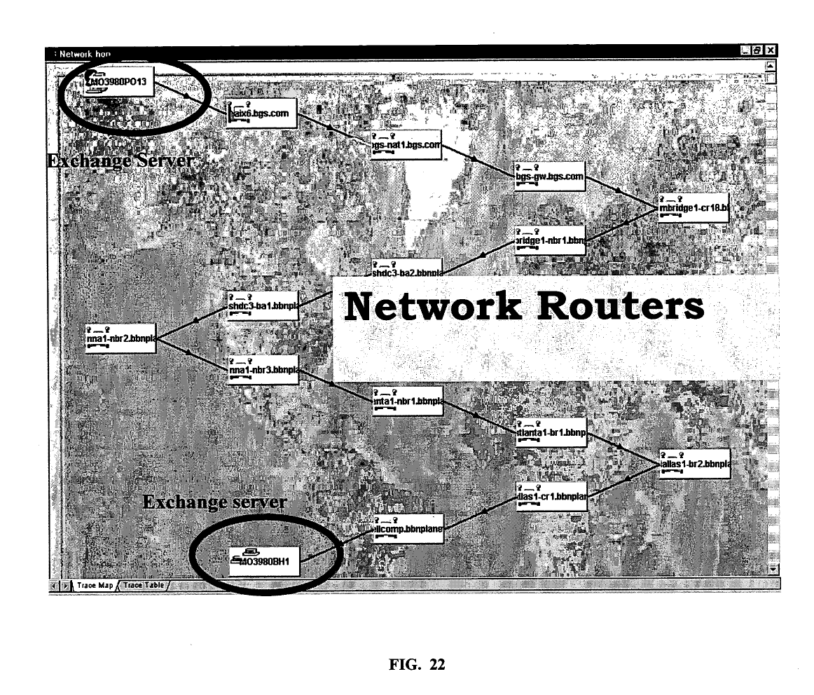

By collecting some performance data on the routers that link the Exchange servers, routers which contribute to the long network latency may be identified. This is illustrated in the network latency graphlet (see FIG. 22). This graphlet shows the network hops between a selected pair of servers. The hops are the bridges and routers that connect the two servers, whether they are LAN or WAN links. In addition to the network addresses of the routers and bridges, the network latencies of these network devices may be estimated. It is noted that there are many choices for the necessary network performance tools.

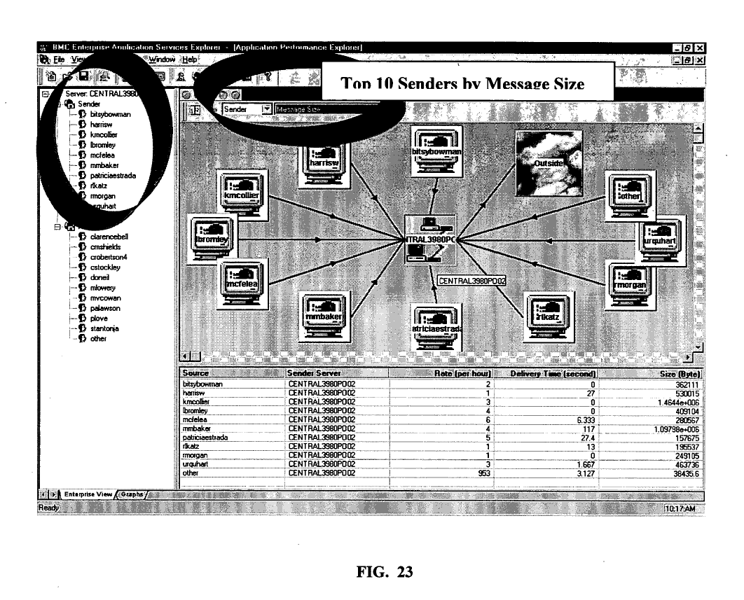

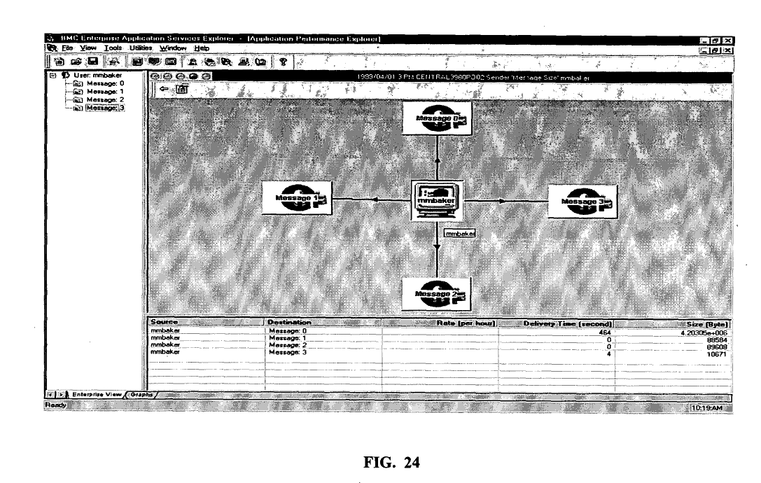

Besides tracking delivery time problems, one may track other messaging problems using the graphlets presented here. One of the most common messaging concerns for email administrators is the potential for email abuse. In the “Web Age,” users tend to send email at the drop of a hat, and the problem is further compounded by the enormous file attachments that are “dutifully” circulated around the company by spirited colleagues. Using the Top 10 Sender graphlet similar to FIG. 18 but based on message size instead of delivery time, one may quickly pinpoint the worst offenders (see FIGS. 23 and 24).

The above examples illustrate how capacity planners may use the enterprise-wide or end-to-end message flow information, optionally in conjunction with enterprise topology view graphlets, to carry out application performance tracking, problem diagnostics and optimization for Exchange. This methodology captures the end-user experience and provides capacity planners with information on the experience of the end users and data on the messages themselves. Capacity planners may now determine very quickly whether the delays in delivery time are due to Exchange servers or to the network links. Even more importantly, the message flow information may identify problematic Exchange servers or network routers. Network router latency metrics from traditional network tools and PerfMon server performance statistics may then be used to complete the root-cause analysis of performance problems.

Thus the system described herein allows successful capacity planning for the enterprise Exchange messaging system by determining and managing transaction flow across the enterprise. This enables capacity planners to focus on the end-user experience by, for example, methodically computing end-to-end delivery times. This essentially expands the horizons of traditional capacity planning tools. This is a novel approach to capacity planning, and is not intended to replace any traditional server-centric or network-centric tool. Instead, the system and method described herein is designed to empower capacity planners to design a system around the end-user experience, which is today the formula for successful e-Business.

Although the system and method of the present invention have been described in connection with several embodiments, the invention is not intended to be limited to the specific forms set forth herein, but on the contrary, it is intended to cover such alternatives, modifications, and equivalents as may be reasonably included within the spirit and scope of the invention as defined by the appended claims.

What is claimed is:

1. A method of tracking messages in an electronic mail messaging system, wherein the electronic mail messaging system includes a plurality of Microsoft Exchange servers, the method comprising:
logging message header information regarding an email message transferred through a first one of said plurality of Microsoft Exchange server in a log file;
examining the message header information regarding the email message;
correlating the message header information with message header information in log files from other ones of said plurality of Microsoft Exchange servers through which the message has transferred to determine an end-to-end message flow information for the message; and
storing the message flow information in a database.

2. The method of claim 1, wherein said message flow information is useable in adjusting a configuration of the electronic mail messaging system.

3. The method of claim 1, further comprising:
adjusting a configuration of the electronic mail messaging system in response to said message flow information.

4. The method of claim 1, further comprising:
generating one or more reports using the message flow information.

5. The method of claim 4, wherein the reports generated using the message flow information include end-to-end message delivery times.

6. The method of claim 1, wherein the message header information includes two or more of a message id, source server name, destination server name, time stamp information, and size information.

7. The method of claim 1, further comprising:
transferring the message header information from each of the plurality of Microsoft Exchange servers to a central console prior to said examining;
wherein the central console performs said examining, said correlating, and said storing.

8. The method of claim 1, further comprising:
enabling message tracking logs in each of the plurality of Microsoft Exchange servers;
collecting and storing the message header information at each of the plurality of Microsoft Exchange servers;
transferring the message header information from each of the plurality of Microsoft Exchange servers to a central console prior to said examining;
wherein the central console performs said examining, said correlating, and said storing.

9. The method of claim 1, wherein the message originates from a sender server of a client who sends the message, wherein the message propagates through zero or more intermediate servers, and then arrives at a recipient server of a recipient of the message;
wherein said correlating the message header information to determine an end-to-end message flow for each of the messages comprises, for each message, reconstructing the message flow of the message from a sender server to a recipient server.

10. The method of claim 9, wherein said correlating the message information includes:
a) examining a first message header information of a first message from a first server;
b) determining time stamp information of the first message using the first message header information;
c) determining a destination server of the message using the first message header information, wherein the destination server becomes the first server;
d) repeating said steps a-c one or more times until the destination server is the recipient server of the message; and
generating message flow information for the first message.

11. The method of claim 1, wherein the end-to-end message flow comprises a sequence of entrances and exits through one or more of said plurality of Microsoft Exchange servers as well as through one or more network links that connect two or more of said Microsoft Exchange servers.

12. A system for tracking messages in an electronic mail messaging system, wherein the electronic mail messaging system includes a plurality of Microsoft Exchange servers, the system comprising:
a CPU;
a memory medium coupled to the CPU which stores a message tracking program, wherein the message tracking program is executable to:
logging message header information regarding an email message transferred through a first one of said plurality of Microsoft Exchange server in a log file;
examining the message header information regarding the email message;
correlating the message header information of the message header information in log files from other ones of said plurality of Microsoft Exchange servers through which the message has transferred to determine an end-to-end message flow information for the message; and
storing message flow information in a database.

13. The system of claim 12, wherein said message flow information is useable in adjusting a configuration of the electronic mail messaging system.

14. The system of claim 12, wherein a configuration of the electronic mail messaging system is adjusted in response to said message flow information.

15. The system of claim 12, wherein the message tracking program is further executable to generate one or more reports using the message flow information.

16. The system of claim 15, wherein the reports generated using the message flow information include end-to-end message delivery times.

17. The system of claim 12, wherein the message header information includes two or more of a message id, source server name, destination server name, time stamp information, and size information.

18. The system of claim 12, further comprising agent software programs stored in each of the Microsoft Exchange servers which transfer the message information from each of the plurality of Microsoft Exchange servers to a central console, wherein the central console performs said examining, said correlating, and said storing.

19. The system of claim 12, wherein each message originates from a sender server of a client who sends the message, propagates through zero or more intermediate servers, and then arrives to a recipient server of a recipient of the message;
wherein, in correlating the message header information to determine an end-to-end message flow for each of the messages, the message tracking program is further executable to reconstruct the message flow for each message from a sender server to a recipient server.

20. The system of claim 19, wherein, in correlating the message information, the message tracking program is further executable to:
a) examine first message header information of a first message from a first server;
b) determine time stamp information of the first message using the first message header information;
c) determine a destination server of the message using the first message information, wherein the destination server becomes the first server;
d) repeat said steps a)-c) one or more times until the destination server is the recipient server of the message; and
generate message flow information for the first message after a)-d).

21. The system of claim 12, wherein the message flow information describes the end-to-end message flow for each of the messages.

22. A system for tracking messages in an electronic mail messaging system, the system comprising:
a plurality of Microsoft Exchange servers, wherein each respective Microsoft Exchange server logs message header information regarding messages transferred through the respective Microsoft Exchange server;
a plurality of software agents, wherein each of the plurality of software agents is comprised in one of the Microsoft Exchange servers;
a central console coupled to each of the plurality of software agents;
wherein each of the plurality of software agents is operable to transfer the message header information from each of the plurality of Microsoft Exchange servers to the central console;
wherein the central console is operable to:
examine the message header information regarding the messages transferred through each of the Microsoft Exchange servers;
correlate the message header information to determine an end-to-end message flow for each of the messages; and
store message flow information in a database in response to said correlating.

23. A carrier medium which stores program instructions wherein the program instructions are executable to implement the method in claim 1.

24. The carrier medium of claim 23, wherein the carrier medium is a memory medium.
